(19) United States
(12) Patent Application Publication
(10) Pub. No.: US 2002/0129120 A1
(43) Pub. Date: Sep. 12, 2002

(54) Method and apparatus of gateway aggregate

(76) Inventor: Kuo-Chou Tseng, Taipei Hsien (TW)

Correspondence Address: Michael D. Bednarek, SHAWPITTMAN, 1650 Tysons Boulevard, McLean, VA, 22102-4859, US

(21) Appl. No.: 09/848,290

(22) Filed: May 4, 2001

(30) Foreign Application Priority Data
Mar. 1, 2001 (TW) 090104641

(51) Int. Cl. G06F 15/16

(52) U.S. Cl. 709/218; 709/219

(57) ABSTRACT

The objective of the present invention is to provide a method and a computer apparatus for integrating a plurality of gateways and to provide such a gateway aggregate so that a larger service capacity can be accomplished. In one embodiment, the gateways are implemented into low-priced personal computers with minor service capacity in order to lower the cost of the inventive gateway aggregate as compared to prior art. The computer apparatus serves as a portal for mobile devices through which roaming users can get connected to network servers accessible to the gateways and exchange data therewith. Furthermore, the portal computer apparatus distinguishes between connection-oriented and connectionless transmissions and has the two different data transmissions handled properly.

### REFERENCE TO RELATED APPLICATIONS

The present application claims priority to Taiwan application NO. 090104641 entitled “method and apparatus of gateway aggregate” filed on 1ₛₜ Mar. 2001.

### BACKGROUND OF THE INVENTION

1. Field of the Invention

The present invention relates to networking gateways. More particularly, it relates to a combination of gateways integrated under a portal computer to achieve a better performance by adding together the system resources of each of the gateways.

2. Description of the Related Art

Wireless application protocol (WAP) has now become a recognized telecommunication standard for mobile devices such as cell phones, personal digital assistant (PDA), and other wireless internet appliances. It is specially established for small devices and is rendered more compact than most existing networking protocols, yet still preserving a versatile protocol compatibility for wireless communication.

WAP utilizes wireless markup language (WML) to generate WAP contents, or pages, in ways similar to how Internet web pages are generated using hypertext markup language (HTML) according to hypertext transfer protocol (HTTP). Since WAP contents in wireless environments and HTTP contents in wired networks are of different format, for a WAP device to access and to browse HTTP contents now available in wired networks, a gateway is necessary to translate the HTTP contents into WAP contents readable to the WAP device, and vice versa.

FIG. 1 illustrates a WAP gateway 150 communicating between a mobile device 110 and a content server 190. The gateway 150 functions as a mediator between the mobile device 110 within a WAP network and the content server 190 within a HTTP network by translating from one format to the other information that is transferred in-betweens. The HTTP network may comprise Internet, intranet, local area network (LAN), and wide area network (WAN) and other compatible network.

The operation sequence between the mobile device 110 and the content server 190 through the WAP gateway 150 according to prior art is described in the following steps.

1. User sends through the mobile device 110 a uniform resource locator (URL) request in binary format to the WAP gateway.

2. The WAP gateway 150 decodes the request massage and translates the request line and request header (in binary format) to HTTP format by a mapping table.

3. The WAP gateway 150 creates a connection to the content server 190 and sends an HTTP request to it.

4. The content server 190 processes the HTTP request. If the URL refers to a static file, the content server 190 fetches the file and gives a response with an HTTP reply header. If the URL refers to a script application, the content server 190 starts the application.

5. The content server 190 returns to the WAP gateway 150 an HTTP reply message, which contains data or results from the script application.

6. The WAP gateway 150 encodes the reply and translates the well-known HTTP formatted reply line and reply header into binary format using the mapping table.

7. The WAP gateway 150 creates a connection, and a response containing the wireless markup language (WML) is returned to the mobile device 110.

The gateway is an essential component to the operation of the WAP technology. With the help of the translating gateway connecting on the one hand to existing wired networks and on the other hand to WAP devices, one easily extends the services and resources of the wired networks to mobile users in the wireless realm.

### SUMMARY OF THE INVENTION

It is known that gateways presently sold on the market are rather costly. The more users and capacity a gateway can support, the more costly it becomes. For wireless services providers or intranet planner constructing a wireless communication environment, such high costs are at times unaffordable and therefore need to be overcome.

A solution is provided herein to reduce the cost of using gateways in the construction of a wireless communication system. According to the inventive conception as disclosed herein, a plurality of gateways are integrated under a common computer unit that serves as a portal through which a mobile user gets connected to one of the integrated gateways and is therefore able to have access to the wired networks. The gateways are preferably commercial low-priced, free, or open source gateways upon which no modifications have to be made for the purpose of the present invention, thereby reducing the cost of the gateway aggregate.

The objective of the present invention is to provide a computer apparatus for integrating a plurality of gateways and to provide such a gateway aggregate so that a larger service capacity can be accomplished. In one embodiment of the present invention, the gateways are implemented into low-priced personal computers with minor service capacity in order to lower the cost of the inventive gateway aggregate as compared to prior art. The computer apparatus serves as a portal for mobile devices through which roaming users can get connected to network servers accessible to the gateways and exchange data therewith. Furthermore, the portal computer apparatus distinguishes between connection-oriented and connectionless transmissions and has the two different data transmissions handled properly.

The objective of the present invention is also to provide a method for integrating a plurality of gateways mediating between first transmission protocol and second transmission protocol, with the benefits of lower cost and comparable aggregate service capacity as compared to prior art. In one embodiment, the first transmission protocol is wireless application protocol (WAP), and the second protocol is hypertext transfer protocol (HTTP).

### BRIEF DESCRIPTION OF THE DRAWINGS

The following detailed description, which is given by way of example, and not intended to limit the invention to the embodiment described herein, can best be understood in conjunction with the accompanying drawings, in which:

FIG. 1 illustrates according to prior art the WAP gateway architecture comprising a gateway.

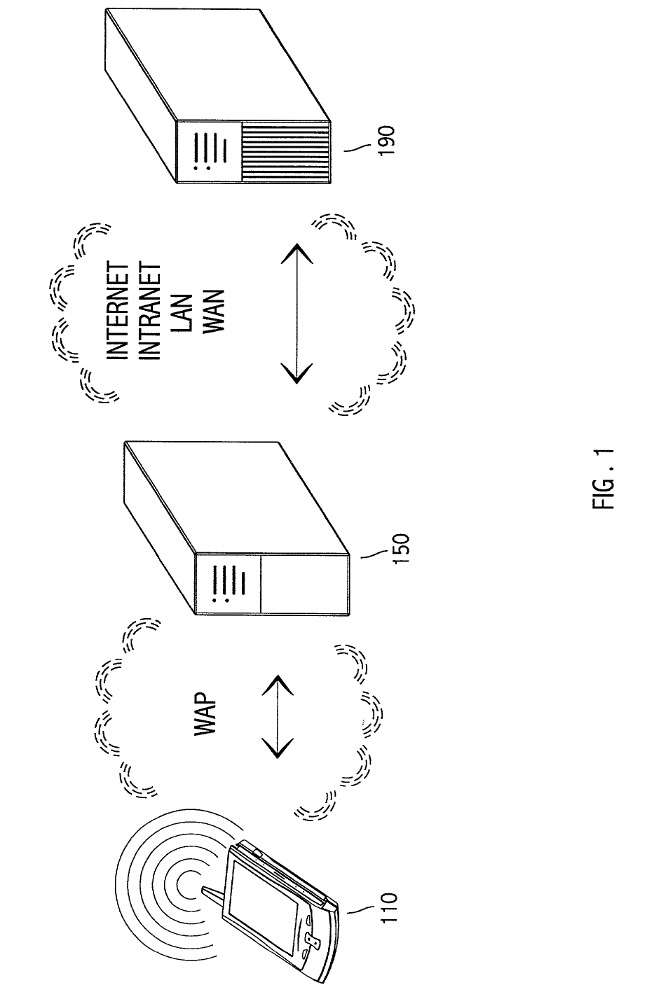

FIG. 2 illustrates according to the present invention the WAP architecture comprising a number of gateways.

FIG. 3 illustrates according to the present invention the flow chart of the dispatcher of the WAP gateway aggregate.

### DETAILED DESCRIPTION OF THE INVENTION

An alternative to conventional gateway is provided herein according to the present invention that overcomes the problem encountered in prior art and economizes the cost of gateway. A plurality of WAP gateways, preferably outdated, low-priced, or free personal computers, are connected in parallel to a computer system wherein are provided hardware and software components that manage the message flows between the computer system and each of the gateways and thereby integrate the connected gateways as one gateway. Each of the connected gateways functions as conventional gateway connecting to Internet or other HTTP networks, but only with service capacity smaller than that of conventional gateway due to limited power of CPU and memory size. It is by integrating each of the connected gateways and combining their separate system resources so that a service capacity comparable to conventional gateway is achieved. Although the inventive gateway aggregate disclosed herein is implemented as a gateway mediating between WAP and HlUP, it is understood by one skilled in the art that the present invention is applicable to other transmission protocols as well.

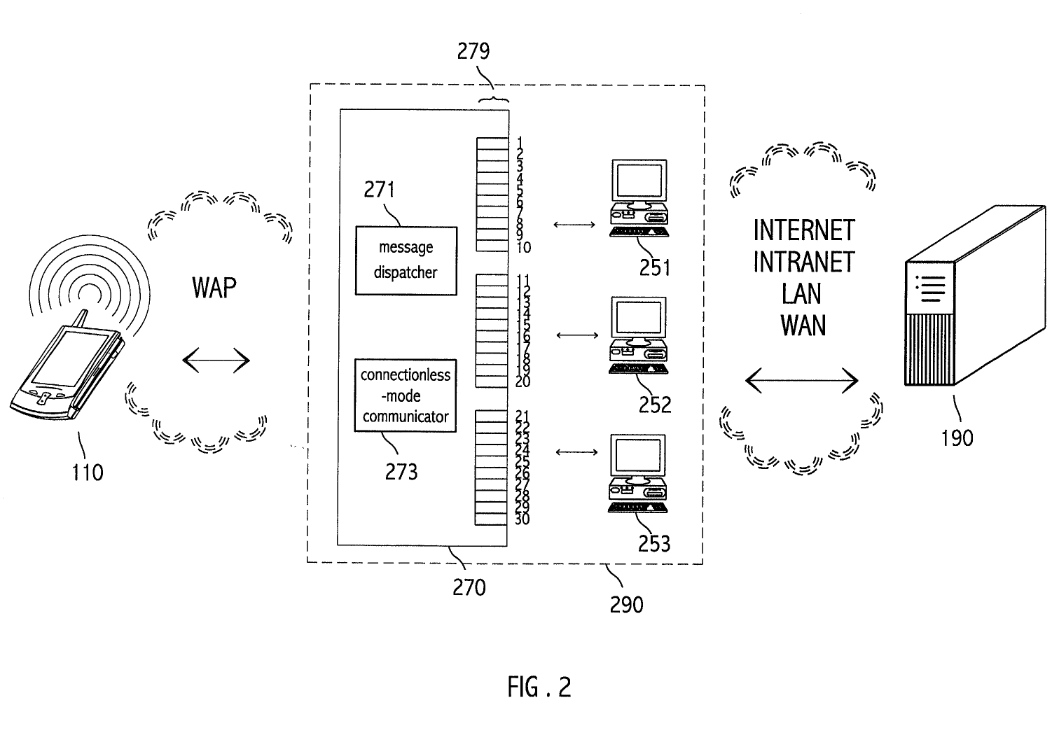

FIG. 2 illustrates according to the present invention the WAP gateway architecture comprising a number of gateways integrated together. As an illustrative embodiment, the gateway aggregate 290 comprises three micro-gateways 251˜253 and an integrator 270 connecting thereto in parallel. The micro-gateways 251˜253 are preferably low-priced personal computers made into WAP gateways with minor service capacities, and the integrator 270 is a separate computer system that integrates micro-gateways 251˜253 into the gateway aggregate 290 as will be described below. The gateway aggregate 290 wirelessly communicates with mobile device 110 through the integrator 270 and communicates on line with content server 190 through the micro-gateways 251˜253, allowing the user of the mobile device 110 to exchange text, visual, and audio data or mere electronic signals with the content server 190, and thereby bringing wired network access to a mobile user.

It is noted that, in the present invention, the connection and communication between the integrator 270 and the mobile user end on the one hand, and the connection and communication between the micro-gateways 251˜253 and the server end on the other hand, are implemented in the same way as prior art and are understood by one skilled in the art. Accordingly, detailed description of the present invention hereinafter will focus on the internal operations of the gateway aggregate 290.

As shown in FIG. 2, the integrator 270 connects to the micro-gateways 251˜253 through numerous ports 279, each port having its own socket port number. In the illustrative embodiment, port 1 to port 10 are connected to micro-gateway 251, port 11 to port 20 are connected to micro-gateway 252, and port 21 to port 30 are connected to micro-gateway 253. The integrator 270 receives wireless messages from user end and distributes them among the micro-gateways 251˜253 for further processing through ports of different port numbers. It is noted that the quantity of micro-gateways that can be incorporated together under the integrator 270 and the quantity of their corresponding ports are subject to modification and are not limited to those illustrated in the present embodiment. The anticipated number of users and throughput are the main concerns in determining the number of micro-gateways to be used.

Above is a disclosure of the internal hardware connections of the gateway aggregate 290 according to the present invention. In the software aspect, the integrator 270 comprises a message dispatcher 271 and a connectionless-mode communicator 273. The dispatcher 271 is a thread whose function is to receive wireless messages from the user end, select for each message one micro-gateway from the group of micro-gateways 251˜253 in accordance with one predetermined rule to be described below, and forward each message to the micro-gateway selected for further processing. For the reason that WAP supports connection-oriented and connectionless data transmission, it is required that the message dispatcher 271 distinguish the transmission mode of each message received and thereby have each message processed properly. According to the present invention, for a connection-oriented message, the dispatcher 271 dynamically selects a port, and therefore a micro-gateway connecting thereto, and opens a corresponding socket for handling the transmission between the micro-gateway selected and the mobile user device issuing the message. On the other hand, for a connectionless message, the transmission control is transferred from the dispatcher 271 to the connectionless-mode communicator 273.

The connectionless-mode communicator 273 is also a thread, normally in idle mode. When a connectionless message originating from the mobile device 110 is received on the gateway aggregate 290, the dispatcher 271 awakens communicator 273 into active mode and hands over the message thereto. Being awakened and then receiving the message from the dispatcher 271, the communicator 273 creates for data transmission a half-duplex channel linking the mobile device 110 and a micro-gateway, say, micro-gateway 251, selected in accordance with the predetermined rule, and then forwards the message to the micro-gateway 251 for further processing. After the micro-gateway 251 has processed the message, e.g., fetching the contents that the message requests, and returns the result to the mobile device 110, the communicator 273 closes the half-duplex channel, and returns back to idle mode.

On the other hand, when a connection-oriented message originating form the mobile device 110 is received on the gateway aggregate 290, the dispatcher 271 opens a socket and creates a full-duplex channel linking the mobile device 110 and a micro-gateway, say, micro-gateway 252, selected in accordance with the predetermined rule, and then forwards the message to the micro-gateway 252 for further processing. Through the socket the mobile device 110 makes request to the micro-gateway 252, and subsequently the micro-gateway 252 responds with the result to the mobile device 110. The socket will be destroyed as understood by one skilled in the art when the transmission between the mobile device 110 and the micro-gateway 252 is terminated.

The rule according to which a micro-gateway is selected for processing and responding a user message is predetermined based on considerations that the response time of the selected micro-gateway processing the user message is to be made as short as possible, and that the system resources of each of the micro-gateways can be utilized evenly and efficiently. For example, in the embodiment of FIG. 2, when eight out of ten ports of the micro-gateway 251 are busy, nine out of ten ports of the micro-gateway 252 are busy, and nine out of ten ports of the micro-gateway 253 are busy, a new incoming user message is forwarded to micro-gateway 251, so that the burden can be evenly distributed among each of the micro-gateways 251˜253, for forwarding the new incoming message to micro-gateway 252 or 253 will have them operate in their full service capacity, which causes not only an uneven distribution of loading but also degraded operation efficiency. The rule of thumb is spreading and making even the loadings of the micro-gateways according to CPU processing speeds of the micro-gateways and throughputs.

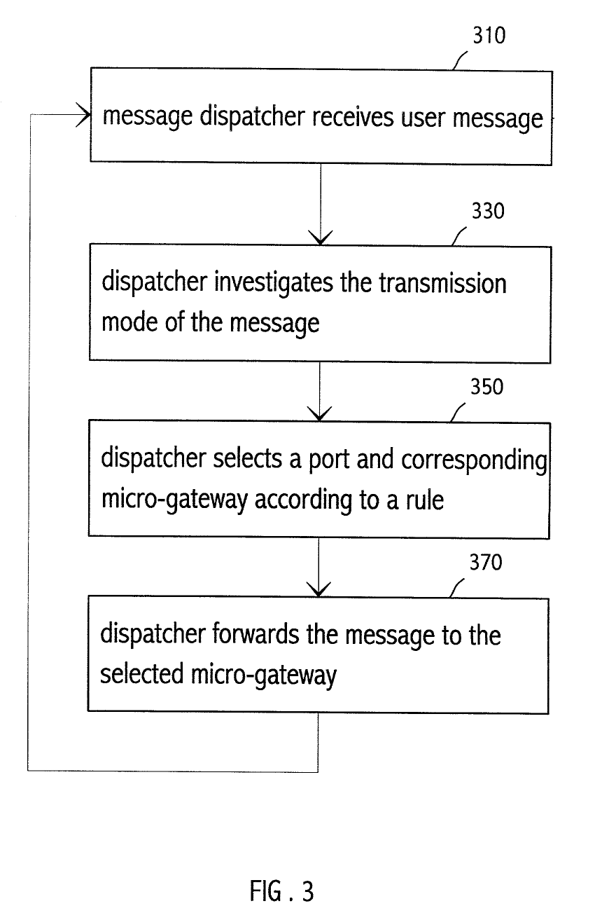

FIG. 3 illustrates according to the present invention the flow chart of the dispatcher software program. In step 310, the dispatcher receives a user message originating from a mobile device. In step 330, the dispatcher investigates the message in order to identify the transmission mode that the message uses, whether connection-oriented or connectionless. In step 350, the dispatcher selects in accordance with the rule described above a port and corresponding micro-gateway for handling the message. In step 370, the dispatcher forwards the message to the selected micro-gateway for further processing through the selected port, either by creating a full-duplex channel if the message is identified to be connection-oriented, or by creating a half-duplex channel if the message is connectionless, and subsequently the dispatcher program returns to step 310 and begins to handle next user message following the same steps.

It is to be noted that the embodiment and particular features and functions as disclosed herein are for the purpose of disclosure only and are not in any sense for limiting the scope of the invention. Small modifications and juxtapositions of one or more of the functional elements anticipated by those skilled in the art without departing the spirit of the present invention is to be regarded as a part of the invention. Therefore, that the scope of present invention is determined by the appended claims is fully understood.

What is claimed is:

1. A combination of gateways using wireless application protocol (WAP) for mediating between a mobile device and network resources, comprising:
a plurality of gateways connecting to said network and having access to said network resources; and
a computer apparatus connecting to said gateways in parallel
for receiving a message from said mobile device;
for forwarding said message for further processing to one of said gateways that is selected according to a predetermined rule;
for receiving the response of said selected gateway to said message; and
for forwarding said response to said mobile device.

2. The combination of gateways according to claim 1, wherein the network utilizes hypertext transfer protocol (HTTP).

3. The combination of gateways according to claim 1, wherein said network resources reside in a server.

4. The combination of gateways according to claim 1, wherein said computer apparatus connects to each of said gateways through a plurality of ports respectively.

5. The combination of gateways according to claim 1, wherein said computer apparatus dynamically creates a full-duplex channel linking said mobile device and said selected gateway when said message is connection-oriented.

6. The combination of gateways according to claim 1, wherein said computer apparatus creates a half-duplex channel linking said mobile device and said selected gateway when said message is connectionless.

7. The combination of gateways according to claim 1, wherein said rule is based on a comparison between the service loadings of each of said gateways.

8. The combination of gateways according to claim 1, wherein said rule is to select for said message the least loaded one of said gateways.

9. The combination of gateways according to claim 1, wherein said gateways are preferably low-priced personal computers.

10. A method for integrating a plurality of gateways that mediate between a mobile device utilizing first transmission protocol and network resources utilizing second transmission protocol, comprising:
providing said gateways connecting to said network and having access to said network resources; and
providing a computer apparatus connecting to said gateways in parallel
for receiving a message from said mobile device;
for forwarding said message for further processing to one of said gateways that is selected according to a predetermined rule;
for receiving the response of said selected gateway to said message; and
for forwarding said response to said mobile device.

11. The method according to claim 10, further comprising providing a plurality of ports through which said computer apparatus connects to each of said gateways respectively.

12. The method according to claim 10, wherein said rule is based on a comparison between the service loadings of each of said gateways.

13. The method according to claim 10, wherein said rule is to select the least loaded gateway among said gateways.

14. The method according to claim 10, wherein said gateways are preferably low-priced personal computers.

15. The method according to claim 10, wherein said first transmission protocol is wireless application protocol (WAP).

16. The method according to claim 10, wherein said second transmission protocol is hypertext transfer protocol (HTTP).

17. A method for operating a plurality of gateways connecting in parallel to a computer apparatus that mediate, as one gateway, between a mobile device utilizing first transmission protocol and network resources utilizing second transmission protocol, comprising:
providing on said computer apparatus hardware and software components
for receiving a message from said mobile device;
for forwarding said message for further processing to one of said gateways that is selected according to a predetermined rule;
for receiving the response of said selected gateway to said message; and
for forwarding said response to said mobile device.

18. The method according to claim 17, wherein said rule is to select the least loaded gateway among said gateways.

19. The method according to claim 17, wherein said gateways are preferably low-priced personal computers.

20. The method according to claim 17, wherein said first transmission protocol is wireless application protocol (WAP).
